(19) United States
(12) Patent Application Publication
(10) Pub. No.: US 2016/0350526 A1
(43) Pub. Date: Dec. 1, 2016

(54) 3D PRINTER UNLOCK SYSTEM

(71) Applicant: John S. YOUNGQUIST, Niagara Falls (CA)

(72) Inventor: John S. YOUNGQUIST, Niagara Falls (CA)

(21) Appl. No.: 15/165,683

(22) Filed: May 26, 2016

Related U.S. Application Data
(60) Provisional application No. 62/166,982, filed on May 27, 2015.

(51) Int. Cl. G06F 21/44; H04L 9/06

(52) U.S. Cl. CPC G06F 21/44; H04L 9/0625

(57) ABSTRACT

A processor chip circuit emulates an original equipment manufacturer (OEM) EEPROM on a replaceable consumable for a 3D printer to circumvent an OEM electronic lock-out system of the 3D printer. The processor chip circuit includes a microprocessor having stored thereon an algorithm to selectively create a random unique serial number and encrypted text that passes all integrity tests of the OEM 3D printer.

### CROSS-REFERENCE TO RELATED APPLICATIONS

This application claims the benefit of U.S. Provisional Application Ser. No. 62/166,982, filed May 27, 2015, which is incorporated herein by reference in its entirety.

### TECHNICAL FIELD

The present technology relates generally to devices for circumventing electronic lock-out systems, and more particularly to devices for circumventing electronic lock-out systems for replaceable consumables in 3D printers.

### BACKGROUND

3D printers build items in thin successive layers, e.g., with a fine stream of molten thermoplastic using a process called Fused Deposition Modeling (FDM). Acrylonitrile butadiene styrene (ABS) is the most widely used material; however polycarbonate, Acrylonitrile Styrene Acrylate (ASA), nylon and other materials are options on some printers. Other 3D printers may use different raw materials and processes as those in the art will appreciate.

The raw material may be available in filament form, e.g., 1.75 mm in diameter, on replaceable consumable units such as spools. For example, a user can purchase 12-inch diameter spools holding roughly 3.5 lbs of material.

Many printer manufacturers design their printers to accept filament spool cartridges manufactured under their brand and to reject cartridges manufactured by others. More particularly, to increase sales of their replacement cartridges, printer manufacturers have added electronic identification features to the printers and to the cartridges that do not enhance the functional performance of the printer in any way but which serve only to prevent use of a competitor's cartridge in the printer. Printer manufacturers also prefer to sell new cartridges to replace empty cartridges. Therefore, they do not support the re-cycling industry.

One 3D printer manufacturer packages its material in a metal canister with desiccant to keep it dry. The canister and printer also employ an electronic lock-out system to prevent use of a competitor's cartridge. The canister has a printed circuit board (PCB) with a single 8 pin chip on it The chip on the PCB is sold by Maxim Integrated and has 512 bytes of non-volatile memory (e.g., EEPROM) and a 64-bit unique laser written serial number on it. The EEPROM is Maxim product DS24B33, as described in the 23 page product specification 19-5759; Rev 3; 5/12 which is hereby incorporated herein by reference. The PCB communicates over a single-conductor 1-Wire bus according to a known so called 1-Wire protocol. The printer can read the serial number and also read/write the EEPROM over the 1-Wire interface. The EEPROM also stores data related to the material in the canister, e.g., plastic type, color, full amount, amount left, manufacturing date, etc.

This data is written to the chip in encrypted form, e.g., using the Data Encryption Standard (DES) algorithm with parts of the serial number and other data bits being used as the key. Since each serial number is unique, no two chips are exactly alike even though they might contain the same data. The printer periodically updates the amount of material left in the canister as it is consumed. This data is also encrypted.

The printer saves the serial number of each used canister so as to thereafter prevent a user from reusing the same canister by simply refilling the spool and rewriting the chip to its original “full” amount state. Thus, the original EEPROM is designed to be a single-use device. Once the spool of material is depleted, the serial number associated with that canister and spool is thereafter locked out.

Therefore, there is a need for a device to circumvent these original manufacturer electronic lock-out systems, in order to provide convenient, affordable and environmentally-friendly options for replaceable consumables.

### SUMMARY

One aspect of the disclosed technology relates to a processor chip circuit that emulates an original equipment manufacturer (OEM) EEPROM on a replaceable consumable for a 3D printer but which has been configured to circumvent an electronic lock-out system of the 3D printer. The example processor chip circuit includes a microprocessor having stored thereon an algorithm to selectively create a unique serial number that passes the integrity tests of the 3D printer.

One exemplary processor chip circuit for emulating an OEM EEPROM on a replaceable consumable for a 3D printer to circumvent an electronic lock-out system includes a microprocessor using a stored program to execute an algorithm that selectively creates a unique serial number different from any other serial number previously used in the 3D printer. The microprocessor is further programmed to replicate the OEM EEPROM system. For example, in one case the microprocessor is programmed to 1) create a 64-bit key, 32 bits of the key being from the generated unique serial number; 2) encrypt a plain text data record stored on the microprocessor, the plain text data record including a material quantity data held indicating that the material quantity is full; and 3) communicate the serial number and encrypted text data record to the 3D printer (e.g., using 1-wire protocol) such that the 3D primer accepts the serial number and encrypted text data record as confirmation of an installed new authorized OEM replaceable consumable having a full material quantity.

One exemplary method of emulating an OEM EEPROM on a replaceable consumable for a 3D printer to circumvent an electronic lock-out system includes selectively running an algorithm on a microprocessor to create a random unique serial number different from any other serial number used in the 3D printer; creating a 64-bit key with the microprocessor, 32 bits of the key being from the serial number; encrypting with the microprocessor, a plain text data record, the plain text data record including a material quantity data field indicating that the material quantity is full; and communicating the serial number and encrypted text data record to the 3D printer (e.g., using I-wire protocol), wherein the 3D printer accepts the serial number and encrypted text data record as confirmation of an installed new authorized OEM replaceable consumable having a hill material quantity.

Other aspects, features, and advantages of the present technology will become apparent from the following detailed description when taken in conjunction with the accompanying drawings, which are a part of this disclosure and which illustrate, by way of example, different aspects of this technology.

### BRIEF DESCRIPTION OF THE DRAWINGS

The accompanying drawings facilitate an understanding of various embodiments wherein:

FIG. 1 is a circuit diagram of a processor chip circuit according to an example of the disclosed technology;

FIG. 2 is a functional block diagram representing a refill mode process of a microprocessor of the processor chip circuit;

FIG. 3 is a functional block diagram representing an emulation mode process of the microprocessor of the processor chip circuit;

FIG. 4 is a functional block diagram representing a memory mode process of the microprocessor of the processor chip circuit;

FIG. 5 is a schematic representation of the memory in the processor chip circuit according to an example of the disclosed technology;

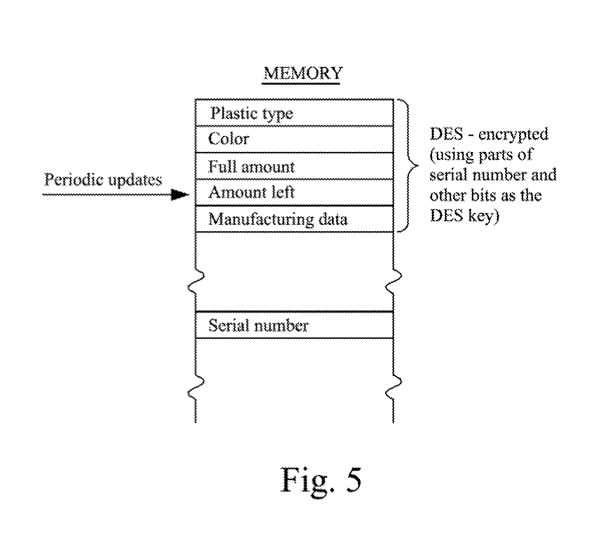

FIG. 6 is a perspective view of a non-OEM spool unit according to an example of the disclosed technology;

FIG. 7 is a side view of the non-OEM spool unit of FIGS. 6; and

FIG. 8 is a front view of the non-OEM spool unit of FIG. 6.

### DETAILED DESCRIPTION OF EXAMPLE EMBODIMENTS

The following description is provided in relation to several examples (most of which are illustrated) which may share some common characteristics and features. It is to be understood that one or more features of any one example may be combinable with one or more features of the other examples. In addition, any single feature or combination of features in any of the examples may constitute additional examples.

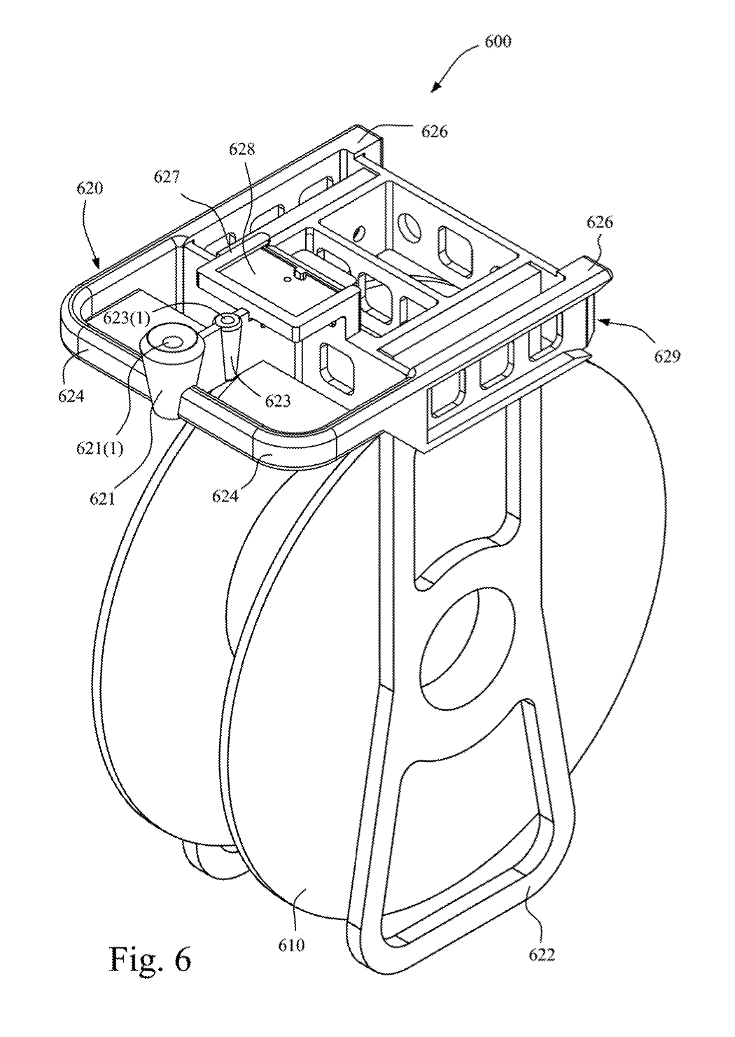

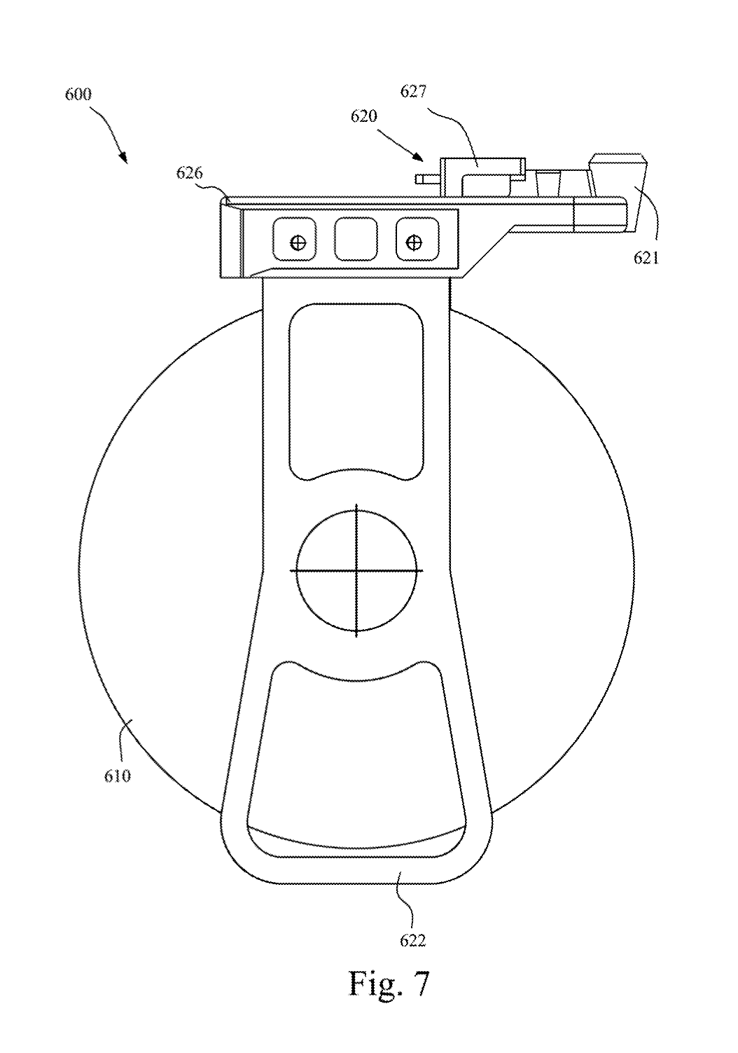

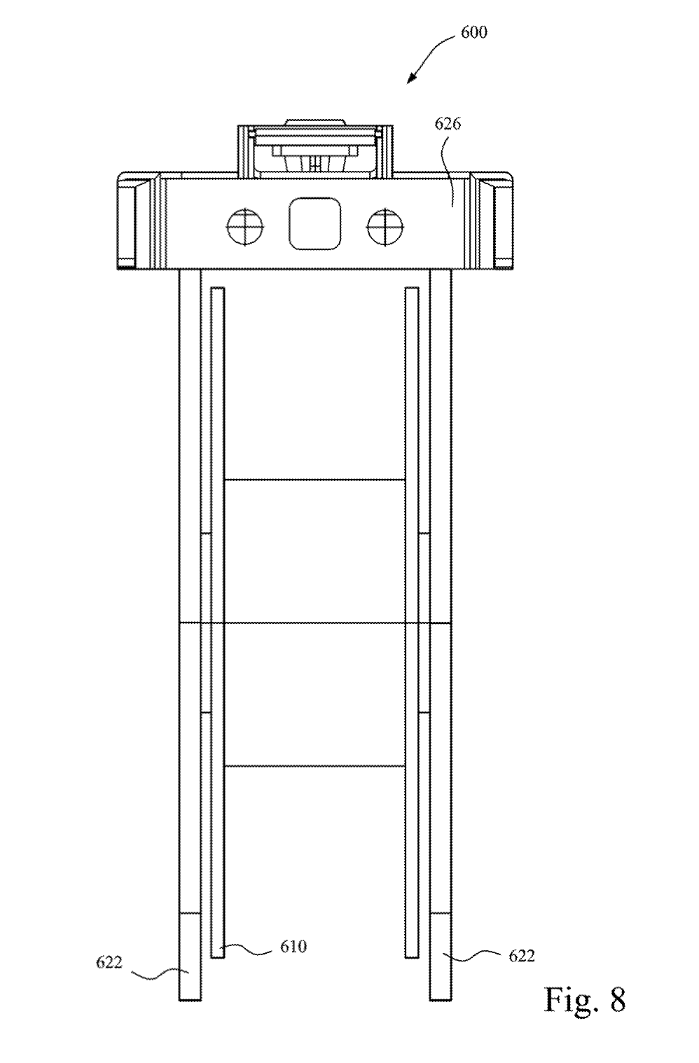

Referring to FIGS. 6-8, a non-OEM spool unit 600 which is configured to hold filament material for use in a 3D printer is shown. Non-OEM spool unit 600 includes spool 610 and spool adapter 620. Spool 610 is configured to hold a roll of filament material thereon. Spool adapter 620 includes a pair of legs 622 arranged to hold spool 610 and a main body 626 connected to the legs and configured to interface with the 3D printer.

Still referring to FIGS. 6-8, main body 626 includes a pair of guide rails 629 on opposite sides thereof to receive a corresponding structure on the 3D printer as non-OEM spool unit 600 is inserted into the 3D printer. A user may grasp handles 624 when maneuvering non-OEM spool unit 600. Main body 626 also includes a filament guide 621 disposed between handles 624. Filament guide 621 includes a through-hole 621(1) through which filament material is fed upwardly to the 3D printer when non-OEM spool unit 600 is inserted therein. The filament guide is positioned on main body 626 so as to appropriately align the filament material with the 3D printer.

When non-OEM spool unit. 600 is not inserted in the 3D printer, an end portion of the filament material may be parked in through-hole 623(1) formed in a filament holder 623 which is disposed adjacent filament guide 621, as best shown in FIG. 6.

Referring to FIG. 6, a printed circuit hoard (PCB) 628 may be mounted in PCB holder 627 which is arranged on main body 626 adjacent filament holder 623, PCB 628 is configured to connect electronically to the 3D printer when non-OEM spool unit 600 is inserted into the 3D printer.

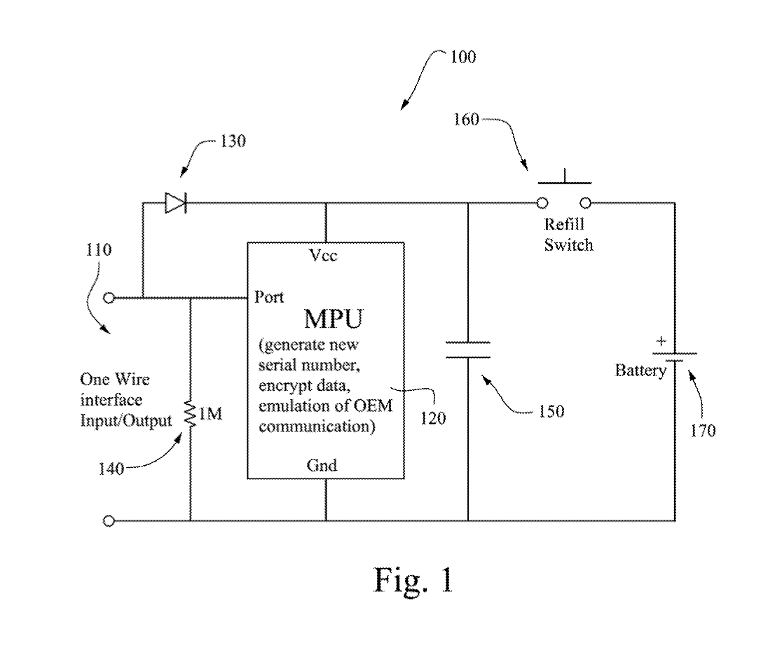

Turning now to FIG. 1, a processor chip circuit 100 which is contained on PCB 628 is illustrated. The processor chip circuit includes a 1-Wire interface 110 configured to communicate with the 3D printer via the 1-Wire protocol, as those skilled in the art will understand.

Still referring to FIG. 1, the processor chip circuit 100 is configured to circumvent an electronic lock-out system of the 3D printer (e.g., the electronic lock-out system of the printer described above in the Background section) thereby enabling a user to simply refill or replace spool 610 on non-OEM spool unit 600 for reuse in the 3D printer.

Processor chip circuit 100 includes microprocessor 120 (e.g., 8-bit). Microprocessor 120 is configured to emulate the Maxim non-volatile memory (e.g., Maxim DS24B33 EEPROM). The microprocessor includes about 16K bytes of code space and 1K bytes of RAM space. The microprocessor is powered by the data signal which idles near +5 v most of the time. Diode 130 isolates the microprocessor load from the data input pin so the charge on capacitor 150 can sustain the microprocessor when the data line goes low fir communication purposes. The microprocessor is configured to draw less than 1 ma during normal operation. The microprocessor clock is set to only a few Mhz to minimize current consumption.

Data flows into the microprocessor via the bi-directional serial 1-Wire interface 110. This signal line provides power for the microprocessor via the isolation diode 130 which also charges capacitor 150. The microprocessor port, shown in FIG. 1, has 110 capability. The port is configured as a 5V tolerant open drain driver. Further, the microprocessor may be configured to generate interrupts on rising or falling edge port activity. In normal use, the port is read as an input and also driven as an output to send data back to the 3D printer.

1.0 Operating Modes

Microprocessor 120 functions in two distinct modes. Normally, the microprocessor emulates the functionality of the Maxim DS24B33 EEPROM (described above in the Background section; the functionality is also described in the 23 page product specification 19-5759; Rev 3; 5/12, mentioned above, which is incorporated herein by reference). The 3D printer uses this mode during normal operation to perform tasks such as writing to the memory to update the amount of material left on the spool. This mode is referred to as Normal (or Emulation) mode.

The other mode, Refill mode, is used by the machine operator to refill the machine once a filament spool has been exhausted. This mode may be triggered by the operator with the push of a button to close refill switch 160 (FIG. 1). In Refill mode, microprocessor 120 creates a new encrypted data set with a new unique serial number to imitate a fresh, full filament cartridge or spool unit. The 3D printer is not involved in this process but sees a “new” cartridge when microprocessor 120 is re-used.

1.1 Normal (Emulation) Mode

As mentioned above, during Normal Mode, microprocessor 120 emulates the Maxim DS24B33 EEPROM. The microprocessor has 512 bytes of non-volatile memory, a 32 byte RAM scratch pad and a 64 bit serial number (of which 4 bits are unique) stored in the non-volatile memory (e.g., flash memory). The non-volatile memory is written in 32 byte or smaller increments by writing to the scratchpad first and then transferring to the non-volatile memory. All 512 bytes (or fewer bytes) may be read from the non-volatile memory directly without involving the scratchpad.

The non-volatile memory may be EEPROM, flash memory, or any other suitable memory. EEPROM is a type of non-volatile memory in which individual bytes can be independently read, erased and re-written. Flash memory is a type of EEPROM that may be electrically erased and reprogrammed, and is typically used when larger amounts of static data are to be stored.

During Normal Mode, only the first 113 bytes of the memo actually used although certain OEM units fill the remaining bytes randomly making them appear to be important. In Normal Mode, the microprocessor functions essentially as a memory chip.

The emulation of the original part (DS24B33) requires both RAM and flash memory. The microprocessor allocates 32 bytes of RAM to the scratchpad and allocates 512 bytes of flash memory for the non-volatile storage. The RAM allocation is simple, while the flash memory allocation is not as simple to carry out,

First, some of the flash memory contains the executable code, which of course cannot be disturbed. Second, the flash memory has a life limitation on the number of write cycles performed at any single memory location. The number of possible write cycles is in the 10,000 to 100,000 range.

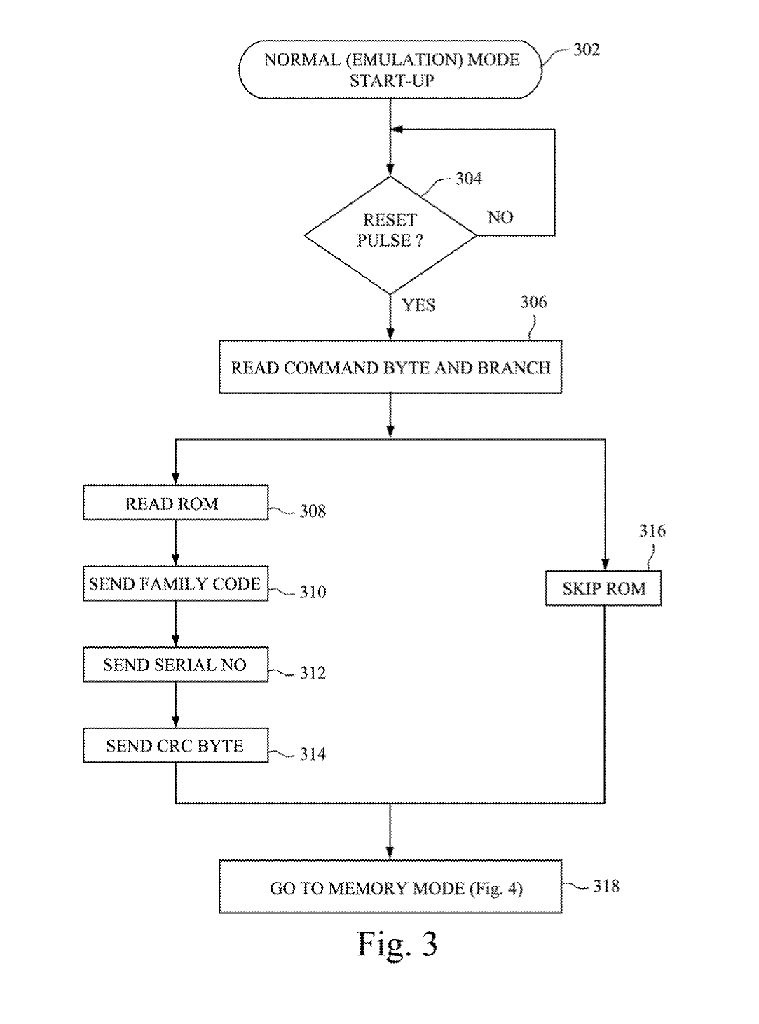

Referring to FIG. 3, in Normal Mode, the 3D printer regularly updates the material quantity data field, which occupies about 12 bytes, while the rest of the data record remains unchanged. To minimize write intensity in a in a given area, the material quantity updates are saved sequentially in a large ring buffer in the flash memory. The most recently written quantity is returned whenever any read to the material quantity address is requested.

Referring to FIG. 3, after start-up at step 302, microprocessor 120 will wait for a reset pulse at step 304. Once a reset pulse occurs, the microprocessor reads a command byte at step 306 and responds accordingly. In order to identify the 64-bit serial number associated with the microprocessor, a read ROM command is issued at step 308. The 64-bit serial number consists of an 8-bit family code byte, a 48-bit unique serial number, and an 8-bit CRC byte, which are requested at steps 310, 312 and 314. Once the 1-wire device (microprocessor 120) has been selected by the master (3D printer), the process proceeds to memory mode at step 318 where the microprocessor is ready to read additional commands from the 3D printer.

If the 64-bit serial number is known, a skip ROM command is issued at step 316, and then the process proceeds directly to memory mode at step 318.

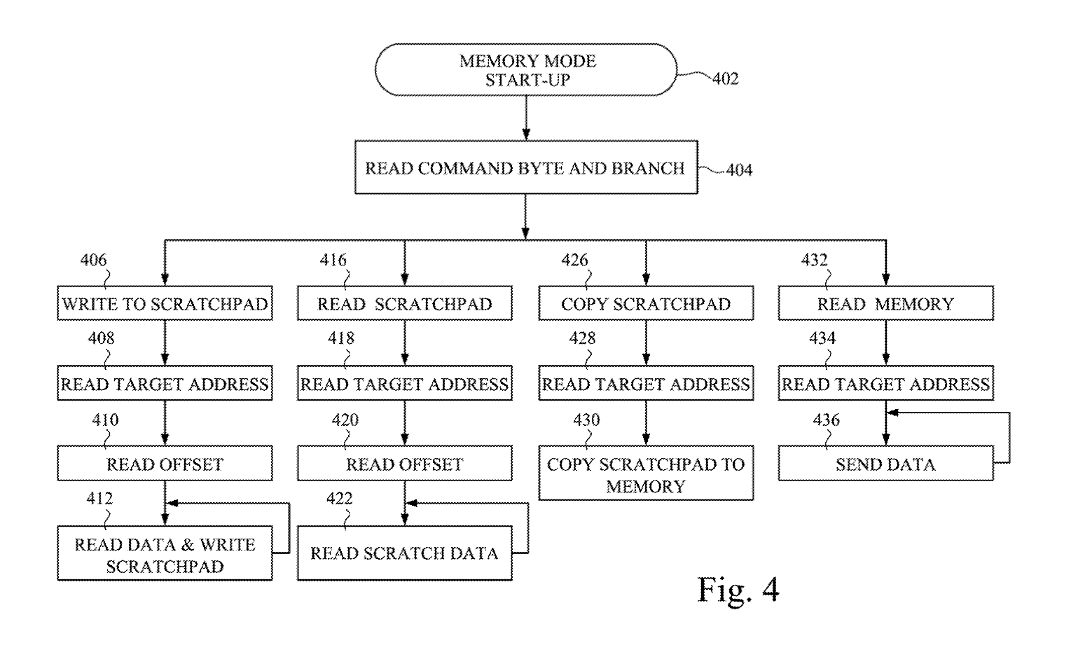

Referring to FIG. 4, memory mode 402, including certain memory functions, is illustrated. At step 404, the microprocessor reads a command byte and responds accordingly.

At step 406, the microprocessor is instructed to write to the scratchpad, which causes the microprocessor to read target address at step 408, read offset at step 410, and read data and write to scratchpad at step 412 (and to loop until this instruction is completed).

At step 416, the microprocessor is instructed to read the scratchpad, which causes the microprocessor to read target address at step 418, read offset at step 420, and read scratch data at step 422 (and to loop until this instruction is completed).

At step 426, the microprocessor is instructed to copy the scratchpad, which causes the microprocessor to read target address at step 428 and copy scratchpad to memory at step 430.

At step 432, the microprocessor is instructed to read the memory, which causes the microprocessor to read target address 434, and send data 436 (and to loop until reset).

1.2 Refill Mode

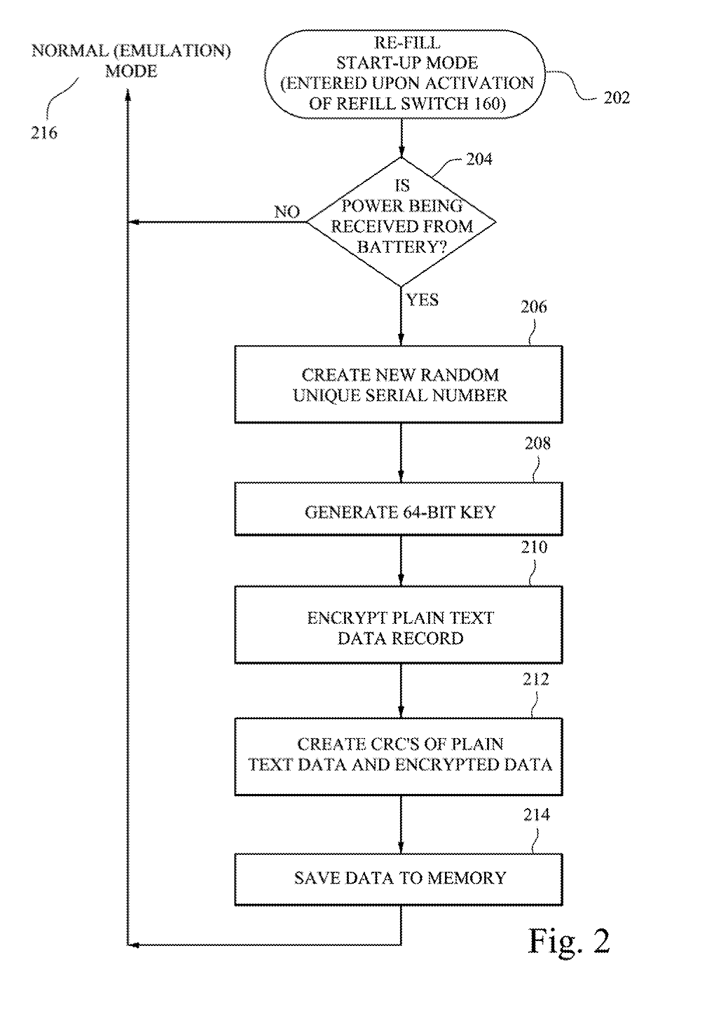

Processor chip 100 includes on-board capabilities to create a new random serial number and to suitably encrypt that data. For example, at the push of a “reset” button on PCB 628, refill switch 160 can be closed to trigger Refill Mode (FIG. 2). Processor chip 100 then independently generates a new serial number causing the chip to appear to the 3D printer as if it is a new non-volatile memory (e.g., flash memory or EEPROM) on a new authorized OEM canister.

Processor chip 100 can be provided on non-OEM spool unit 600. In this manner, a user can simply refill or replace spool 610 and push the “reset” button to re-initialize the non-OEM spool unit for further use.

Refill Mode does not involve the 3D printer, in Refill Mode, microprocessor 120 is powered outside of the 3D printer from an on-board battery 170 (e.g., a lithium battery), as can be seen in FIG. 1. Microprocessor 120 distinguishes battery power from 3D printer power in order to initiate the Refill Mode.

When microprocessor 120 is powered from the 3D printer via diode 130, the input port is driven high at the same time as the power pin is driven high via diode 130. When powered from battery 170, the input port is held low by resistor 140 (e.g., 1 MΩ). By testing the state of the port at power up, the power source can be determined. Other detection techniques may also be employed (e.g., threshold level detection between expected battery voltage level at the Vcc pin versus expected supply power from diode 130).

The microprocessor 120 could be programmed to use another port to drive a transistor in parallel with refill switch 160 to keep power on independently of the operator. This would assure uninterrupted power until completion of the refill process if needed.

The purpose of Refill Mode is to create an encrypted data record which passes the integrity tests conducted by the OEM 3D printer and thereby emulate a new OEM full filament cartridge. This process essentially “cuts a key” to match the printer lock. However, unlike an ordinary door lock, the printer lock never uses the same key twice.

One typical OEM printer lock comprises two data blocks totaling about 72 bytes encrypted (while the remaining are “in the clear” (not encrypted)) with a 64-bit key and uses verification with several 16-bit cyclic redundancy checks (CRC) of both clear and encrypted versions of the data bytes. This process may be intentionally convoluted by the OEM to make decoding difficult. A single erroneous bit will cause the unlock process to fail. The key includes 32 bits from the unique serial number. The unique serial number will never repeat, therefore the encrypted data will never be the same even if the original source data is common.

Microprocessor 120 maintains a plain text version of the data record which is encrypted during Refill Mode. The data record contains various data fields such as material type, color, and quantity. The material quantity field indicates a fill quantity so as to match the material quantity on non-OEM spool unit 600 when the spool is refilled or replaced. Those skilled in the art will recognize that microprocessor 120 could be programmed to reflect a different material quantity (e.g., 95% fill, etc.) and spool 610 could be refilled or replaced accordingly.

As mentioned in the Background section, the Maxim EEPROM stores data related, to the material in the canister, e.g., plastic type, color, full amount, amount left, manufacturing date, etc. Similarly, the processor chip circuit 100 maintains memory with this data, as represented in FIG. 4. The created serial number is also stored in memory.

Referring to FIG. 2, a process of “refilling” microprocessor 120 for further use is described. After start-up at step 202, microprocessor 120 determines whether it is being powered by the 3D primer or battery 170, in step 204. If it is determined that the microprocessor is being powered by the printer, the microprocessor proceeds to function in Normal (Emulation) Mode. However, if it is determined that power is being supplied by battery 170. Refill Mode is initiated.

The refill process begins by creating a new random unique serial number (48 bits long) in step 206. Any suitable conventional random number generator algorithm may be used to generate the serial number. However, the serial number cannot be the same as a previously generated number or any serial number ever used in the 3D printer at issue. When a good randomization algorithm is used, the odds of matching a previous number will approach 1 in 2̂48 (281 trillion). This process is augmented with a static family code byte that identifies the memory chip and uses a special 8-bit CRC for error detection. This is all part of the Maxim DS24B33 standard.

Then, in step 208, a 64-bit key is produced using 32 bits from the random unique serial number. The remaining 32 bits include some static bytes and some bytes in the clear from the data record itself.

In step 210, the just-generated plain text data record is encrypted. CRCs of the plain text and encrypted text are added, in step 212. Finally, this data is saved in non-volatile memory (e.g., flash memory) in step 214.

As mentioned above, the source data now indicates a new full material quantity. As such, the microprocessor can now switch to Normal (Emulation) Mode 216 to carry out a printing operation.

The encryption system may utilize any suitable algorithm designed to work with public keys. Of course, the method selected must exactly match the method used in the 3D printer. The new encrypted data set and the new serial number will be provided by the Normal (Emulation) Mode when the 3D printer reads microprocessor 120 (via I/O port 110) in Normal (Emulation) mode.

Microprocessor 120 could also utilize data from an external source to facilitate special colors, material quantities, etc.

Microprocessor 120 could also be programmed to permit only a certain number of refills, (e.g., 10, 25, 50, 100, etc.) after which the microprocessor could not be further reused.

It is noted that microprocessor 120 could be used on an OEM spool unit.

While the examples discussed above have been described in connection with what are presently considered to be practical and preferred features, it is to be understood that appended claims are intended to cover modifications and equivalent arrangements included within the spirit and scope of these examples.

What is claimed is:

1. A method emulating an original equipment manufacturer (OEM) 3D-printer consumable having an electronic serial number lock-out system designed to prevent use of non-OEM 3D-printer consumables and to prevent re-use of re-tilled OEM 3D-printer consumables, said method comprising:
disposing a microprocessor circuit with an OEM 3D-printer consumable or a non-OEM 3D-printer consumable, said microprocessor circuit being disposed for data communication with an OEM 3D-printer when the associated consumable is connected to an OEM 3D-printer;
selectively adding content to said associated consumable and executing a re-fill algorithm within said microprocessor circuit that generates a new serial number and encrypted consumable-related data representative of a non-empty OEM consumable; and
communicating said new serial number and encrypted data with a connected OEM 3D-printer to emulate connection of an authorized non-empty consumable to said OEM 3D-printer and thereafter permitting use of the added consumable content by the OEM 3D-printer.

2. The method of claim 1, wherein said microprocessor circuit is disposed for 1-wire protocol data communication with the OEM 3D-printer.

3. A 3D-printer consumable emulating an original equipment manufacturer (OEM) 3D-printer consumable having an electronic serial number lock-out system designed to prevent use of non-OEM 3D-printer consumables and to prevent re-use of re-filled OEM 3D-printer consumables, said 3D-printer consumable comprising:
a microprocessor circuit disposed with an OEM 3D-printer consumable or a non-OEM 3D-printer consumable, said microprocessor circuit being disposed for data communication with an OEM 3D-printer when the associated consumable is connected to an OEM 3D-printer,
said microprocessor circuit including a stored program re-fill algorithm that is selectively executed to generate a new serial number and encrypted consumable-related data representative of a non-empty OEM consumable; and
said microprocessor circuit including an input/output (I/O) port using a 1-wire communication protocol to communicate said new serial number and encrypted data with a connected OEM 3D-printer emulating connection of an authorized non-empty consumable to said OEM 3D-printer and thereafter permitting use of the associated consumable by the OEM 3D-printer.

4. The 3D printer consumable of claim 3, wherein said microprocessor circuit is disposed for 1-wire protocol data communication with the OEM 3D-printer.

5. A microprocessor circuit emulating a non-volatile memory of an original equipment manufacturer (OEM) 3D-printer consumable having an electronic serial number lock-out system designed to prevent use of non-OEM 3D-printer consumables and to prevent re-use of re-filled OEM 3D-printer consumables, said microprocessor circuit comprising:
a microprocessor configured for 1-wire protocol data communication with an OEM 3D-printer when an associated consumable is connected to an OEM 3D-printer;
a diode connected between a 1-wire input/output (I/O) port and a microprocessor power port and a capacitor connected to the microprocessor power port for storing electrical energy received via the diode and maintaining microprocessor operation during normal mode data communications while emulating a non-volatile memory;
a series-connected battery and re-fill switch connected to said microprocessor power port for initiating and maintaining microprocessor operation during a re-fill mode; and
computer program memory storing (i) a re-fill program algorithm that is selectively executed when said re-fill switch is activated to generate a new serial number and encrypted consumable-related data representative of a non-empty OEM consumable during a re-fill mode of operation and (ii) a 1-wire communication protocol for use during said normal mode of operation to emulate a non-volatile memory communicating said new serial number and encrypted data when connected to an OEM 3D-printer thus emulating connection of an authorized non-empty consumable to said OEM 3D-printer and thereafter permitting use of the associated consumable by the OEM 3D-printer.

6. A method emulating an original equipment manufacturer (OEM) consumable on a non-OEM replaceable consumable for a 3D primer by circumventing an OEM. electronic lock-out system of the 3D printer, said method comprising:
selectively running a refill algorithm on a microprocessor associated with a non-OEM consumable to create a random unique serial number;
creating a 64-bit key using the microprocessor, 32 bits of the key being from the created serial number;
encrypting, using the microprocessor, a plain text data record, the plain text data record including a consumable material quantity data field indicating that the material quantity is not empty;
connecting the non-OEM consumable and its associated microprocessor to an OEM 3D printer; and
communicating the created serial number and encrypted text data record to the 3D printer using 1-wire protocol,
wherein the OEM 3D printer accepts the created serial number and encrypted text data record as confirmation that an authorized non-empty OEM replaceable consumable has been installed on the OEM 3D printer.

7. The method of claim 6, wherein the microprocessor includes a non-volatile memory and a Random Access Memory (RAM) scratch pad.

8. The method of claim 7, wherein the non-volatile memory is flash memory.

9. The method of claim 6, wherein the microprocessor is configured to selectively receive power from a battery to cause said selectively running of the refill algorithm.

10. The method of claim 9, further comprising determining whether the microprocessor is receiving power from the 3D printer or the battery, and when it is determined that the microprocessor is receiving power from the battery, performing the step of selectively running an algorithm on the microprocessor.

11. The method of claim 6, wherein microprocessor is programmed to limit the number of times that said refill algorithm can be run.

12. A refill processor chip circuit that emulates an original equipment manufacturer (OEM) chip of a 3D printer consumable to circumvent an electronic lock-out system of the OEM 3D printer, said refill processor chip circuit comprising:
a microprocessor having stored thereon a refill algorithm which:
selectively creates a random unique serial number;
creates a 64-bit key, 32 bits of the key being from the serial number;
encrypts a plain text data record stored on the microprocessor, the plain text data record including a material quantity data field indicating that the material quantity is not empty; and
communicates the created serial number and encrypted text data record when connected to an OEM the 3D printer using -wire protocol such that the OEM 3D printer accepts the created serial number and encrypted text data record as confirmation that an authorized non-empty OEM replaceable consumable has been installed thereon.

13. The refill processor chip circuit of claim 12, further comprising a 1-Wire interface configured to communicate with the OEM 313 printer via 1-Wire protocol.

14. The refill processor chip circuit of claim 13, wherein the microprocessor includes an input/output port for bi-directional communication with the 3D printer via the 1-Wire interface.

15. The refill processor chip circuit of claim 14, further comprising:
a capacitor arranged in parallel with the microprocessor;
a diode connected between a microprocessor I/O port and a microprocessor power supply port to charge the capacitor and sustain microprocessor power when communications are passing through the 1-Wire interface; and
a refill switch, which when closed connects a battery to the microprocessor power supply port and initiates the refill algorithm.

16. The refill processor chip circuit of claim 15, wherein the microprocessor is configured to determine whether the microprocessor is receiving power from the 3D printer via the I/O port or from the battery, and when it is determined that the microprocessor is receiving power from the battery, the microprocessor is programmed to initiate the refill algorithm.

17. The refill processor chip circuit of claim 12, wherein the microprocessor is programmed to limit the number of times the refill algorithm can be executed.
